(19) United States
(12) Patent Application Publication
(10) Pub. No.: US 2003/0147635 A1
(43) Pub. Date: Aug. 7, 2003

(54) Information storage medium containing display mode information, and reproducing apparatus and method

(75) Inventors: Kil-soo Jung, Gyeonggi-do (KR); Hyun-kwon Chung, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/359,632

(22) Filed: Feb. 7, 2003

(30) Foreign Application Priority Data
Feb. 7, 2002 (KR) 2002-7031
Sep. 19, 2002 (KR) 2002-57320

(51) Int. Cl. H04N 5/781

(52) U.S. Cl. 386/125; 386/126

(57) ABSTRACT

An information storage medium containing display mode information, and a reproducing apparatus and a method thereof. The information storage medium includes audio/video (AV) data, a markup language document which defines a display window on which an AV screen is output and reproduced based on the AV data in an interactive mode, and mode information indicating a current display mode when the AV screen is displayed in a plurality of modes. With the medium, a user-friendly interface indicates the interactive mode that is not a video mode, even when the current display mode is a full-screen mode that is a subordinate mode of the interactive mode.

### CROSS-REFERENCE TO RELATED APPLICATIONS

This application claims the priority of Korean Patent Application Nos. 2002-7031, filed on Feb. 7, 2002, and 2002-57320, filed on Sep. 19, 2002, in the Korean Intellectual Property Office, the disclosures of which are incorporated herein in their entirety by reference.

### BACKGROUND OF THE INVENTION

1. Field of the Invention

The present invention relates to an information storage medium and reproducing apparatus and method in which audio/video (AV) data recorded on the information storage medium can be displayed in an interactive mode.

2. Description of the Related Art

An interactive digital versatile disc (DVD) in which data can be reproduced in an interactive mode using a personal computer (PC) has been proposed. The interactive DVD represents a DVD on which markup language documents are recorded together with AV data. The AV data recorded on the interactive DVD can be reproduced in two ways. The first one is a video mode in which data is displayed as a normal DVD, and the other one is the interactive mode in which the reproduced AV data is displayed through a display window defined by a markup language document. If the interactive mode is selected by a user, a browser in the PC interprets and displays the markup language document recorded on the interactive DVD. In the display window of the markup language document, the AV data selected by the user is displayed. The markup language document is a hyper text markup language (HTML) document.

For example, when AV data is a movie, moving pictures are output on a screen in the display window of the HTML document, and a variety of additional information, such as a script and a synopsis of the movie, photos of actors, or the like, are displayed on a remaining part of the screen. The additional information includes image files or text files.

However, in the interactive mode which was proposed previously, the AV data is displayed through the display window based on the HTML definition, and accordingly a size of the screen is relatively smaller than that of the video mode. While the user watches the movie in the interactive mode, the user may change the screen mode to the video mode in order to watch the movie displayed on a bigger (enlarged) screen. Then, when the interactive mode is finished, navigation information is initialized such that the movie may be reproduced again from the beginning.

### SUMMARY OF THE INVENTION

The present invention provides a reproducing apparatus and method in which an AV screen can be expanded in an interactive mode.

The present invention also provides an information storage medium on which mode information enabling to distinguish an expanded AV screen in an interactive mode from a video mode is recorded, and a reproducing apparatus and a method thereof.

Also, the present invention provides an information storage medium on which reproducing state information indicating a reproducing state of AV data when an AV screen is expanded in an interactive mode, is recorded, and a reproducing apparatus and a method thereof.

Additional aspects and advantages of the invention will be set forth in part in the description which follows and, in part, will be obvious from the description, or may be learned by practice of the invention.

According to an aspect of the present invention, an information storage medium includes audio/video (AV) data, a markup language document defining a display window on which an AV screen is output and reproduced based on the AV data in an interactive mode, and mode information indicating a current display mode when the AV data is displayed in a plurality of modes.

It is possible that the mode information is to be displayed to overlap the AV screen obtained from the AV data.

It is possible that the mode information is to be displayed on a panel of a reproducing apparatus which reproduces the AV data.

It is possible that the mode information is to be displayed on a display window of the panel.

It is possible that the mode information is to be displayed on a predetermined display apparatus.

It is possible that the mode information is displayed as graphic data.

It is possible that the mode information is to indicate a predetermined upper level mode when the AV screen is displayed in a subordinate mode of the upper level mode.

It is possible that the mode information is to indicate a full-screen mode as a subordinate mode of the interactive mode when the AV screen is displayed in the full-screen mode of the interactive mode.

According to another aspect of the present invention, an information storage medium includes audio/video (AV) data, reproducing state information of an AV screen obtained based on the AV data, and a markup language document defining a display window on which the AV screen is output and reproduced in an interactive mode.

It is possible that the reproducing state information is to be displayed overlapping the AV screen obtained from the AV data.

It is possible that the reproducing state information is to be displayed on a panel of a reproducing apparatus which reproduces the AV data.

It is possible that the reproducing state information is to be displayed on a display window of the panel.

It is possible that the reproducing state information is to be displayed on a predetermined display apparatus.

It is preferable] possible that the reproducing state information is displayed as graphic data.

It is preferable] possible that the reproducing state information is to indicate that the reproduction is paused.

It is possible that the reproducing state information is to indicate that reproduction of the AV data is paused when the AV screen is displayed in a full-screen mode of the interactive mode.

According to another aspect of the present invention, a reproducing apparatus includes a reader which reads AN data from an information storage medium, a decoder which decodes the AV data read by the reader, and a controller which detects a display mode of an AV screen obtained from the decoded AV data, and displays mode information which indicates the detected display mode.

It is possible that the controller displays the mode information overlapping the AV screen obtained from the AV data.

It is possible that the controller displays the mode information on a panel of the reproducing apparatus.

It is possible that the controller displays the mode information on a display window of the panel.

It is possible that the controller displays the mode information on a predetermined display apparatus.

It is possible that the controller displays the mode information which indicates a predetermined upper level mode when the AV screen is displayed in a subordinate mode of the upper level mode.

It is possible that the controller displays the mode information which indicates a full-screen mode as a subordinate mode of an interactive mode when the AV screen is displayed in the full-screen mode of the interactive mode.

According to another aspect of the present invention, a reproducing apparatus includes a reader which reads A/V data from an information storage medium, a decoder which decodes the AV data read by the reader, and a controller which detects information on a reproducing state of an AV screen obtained based on the AV data, and displays the reproducing state information read by the reader.

It is possible that the controller displays the reproducing state information overlapping the AV screen obtained from the AV data.

It is possible that the controller displays the reproducing state information indicating that reproduction of an AV data is paused, so that the reproducing state information overlaps the AV screen in a full-screen mode of an interactive mode.

It is possible that the controller displays the reproducing state information on a panel of the reproducing apparatus.

It is possible that the controller displays the reproducing state information on the display window of the panel.

It is possible that the controller displays the mode information in a predetermined display apparatus.

According to another aspect of the present invention, a reproducing method in which AV data recorded on an information storage medium is reproduced in an interactive mode, includes detecting a display mode of an AV screen obtained from the AV data and displaying mode information which indicates that the display mode is a full-screen mode as a subordinate mode of an interactive mode when the display mode is the full-screen mode.

It is possible that the displaying of the mode information includes displaying the mode information to overlap the AV screen obtained from the AV data.

It is possible that the displaying of the mode information includes displaying the mode information on a panel of the reproducing apparatus.

It is possible that the displaying of the mode information includes displaying the mode information on a display window of the panel.

It is possible that the displaying of the mode information includes displaying the mode information on a predetermined display apparatus.

According to another aspect of the present invention, a reproducing method in which AV data recorded on an information storage medium is reproduced in an interactive mode, includes detecting information on a reproducing state of an AV screen when a display mode of the AV screen obtained from the AV data is a full-screen mode and displaying the reproducing state information which indicates the detected reproducing state of the AV screen.

It is possible that the displaying of the reproducing state information includes displaying the reproducing state information to overlap the AV screen obtained from the AV data.

It is possible that the displaying of the reproducing state information includes displaying the reproducing state information on a panel of the reproducing apparatus.

It is possible that the displaying of the reproducing state information includes displaying the reproducing state information on a display window of the panel.

It is possible that the displaying of the reproducing state information includes displaying the reproducing state information on a predetermined display apparatus.

### BRIEF DESCRIPTION OF THE DRAWINGS

The above and/or other aspects and advantages of the present invention will become more apparent and more readily appreciated from the following description of the preferred embodiments, taken in conjunction with the accompanying drawings of which:

FIG. 1 is a schematic diagram of a reproducing system according to an embodiment of the present invention;

FIG. 2 is a functional block diagram of a reproducing apparatus in the reproducing system shown in FIG. 1;

FIG. 3 is a view showing a remote controller in the reproducing system shown in FIG. 1;

FIG. 4 is an example of a directory structure of a DVD supporting interactive mode in the reproducing system shown in FIG. 1;

FIG. 5 is another example of a directory structure of a DVD supporting interactive mode in the reproducing system shown in FIG. 1;

FIG. 6 is a reference diagram explaining a screen line-up order (Z-order) of a television connected to a reproducing apparatus in the reproducing system shown in FIG. 1;

FIG. 7 is another reference diagram explaining a video mode;

FIG. 8 is another reference diagram explaining an interactive mode;

FIG. 9 is another reference diagram explaining a structure of a screen on which mode information is displayed in the reproducing system shown in FIG. 1;

FIG. 10 is another reference diagram explaining the structure of a screen on which mode information and reproducing state information are displayed in the reproducing system shown in FIG. 1;

FIG. 11 is another reference diagram explaining a screen on which mode information is displayed when the screen mode is in transit from an interactive mode to a full-screen mode that is a subordinate mode of the interactive mode in the reproducing system shown in FIG. 1;

FIG. 12 is another reference diagram explaining a screen on which mode information and reproducing state information are displayed when the screen mode is transited from an interactive mode to a full-screen mode that is a subordinate mode of the interactive mode in the reproducing system shown in FIG. 1;

FIG. 13 is a flowchart explaining a display method in the reproducing system shown in FIG. 1;

FIG. 14 is another flowchart explaining a display method in the reproducing system shown in FIG. 1.

FIG. 15 is a diagram of another reproducing system mode showing information and reproducing state information according to another embodiment of the present invention;

FIG. 16 is another diagram of another reproducing system mode showing mode information and reproducing state information displayed according to another embodiment of the present invention; and

FIG. 17 is another diagram of another reproducing system mode showing mode information and reproducing state information displayed according to another embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

In the present specification, ‘markup language documents’ include not only documents written in markup languages, such as HTML and XML, but also documents where source codes written in script languages or Java are linked or inserted, and in addition indicate files linked to markup language documents. That is, the markup language documents are a kind of application programs which are needed in reproducing AV data in an interactive mode. An ‘AV screen’ represents a screen on which the AV data is reproduced and displayed such that the AV data is sensed by a user's eyes. A ‘markup screen’ is a screen on which a markup language document is reproduced and displayed such that the markup language document is sensed by the user's eyes.

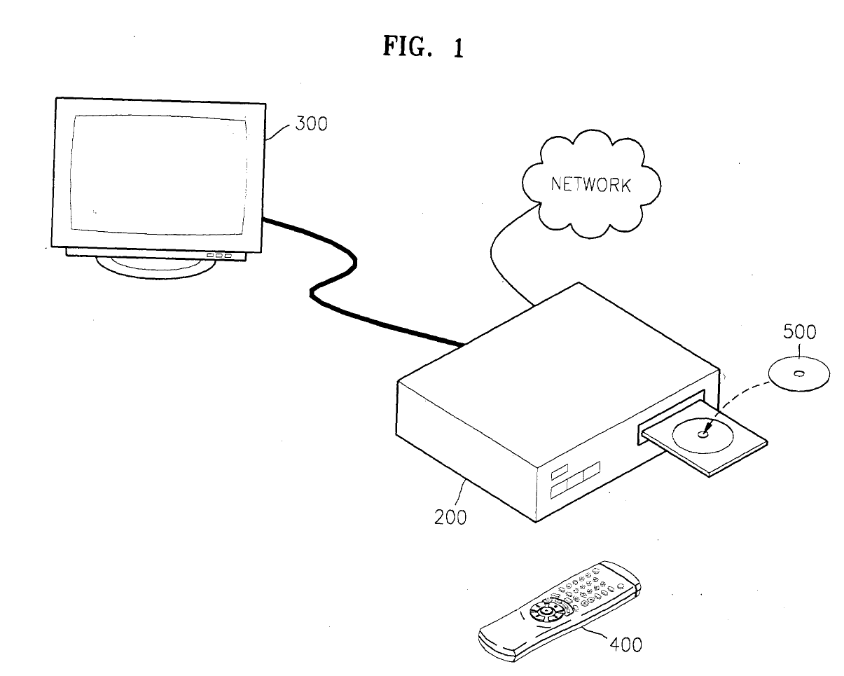

FIG. 1 is a schematic diagram of a reproducing system according to an embodiment of the present invention.

Referring to FIG. 1, the reproducing system includes a disc (DVD) 500, a reproducing apparatus 200, and a television (TV) 300 as a display apparatus, and a remote controller 400. The reproducing apparatus 200 is connected to a network.

The remote controller 400 receives a control command from a user and transmits the control command to the reproducing apparatus 200. If the user selects an interactive mode, the reproducing apparatus 200 reproduces AV data which is recorded on the DVD 500 in response to the control command, and transmits the AV data to the TV 100. A markup language document needed in reproducing data in the interactive mode is fetched from the DVD 500 or the network. If in the interactive mode, the user requests reproducing data in a full-screen mode that is a subordinate mode of the interactive mode, the reproducing apparatus 200 makes an AV screen displayed expand, and mode information and/or reproducing state information are/is displayed to overlap the AV screen. The AV screen, the mode information, and the reproducing state information are displayed on a display screen of the TV 100.

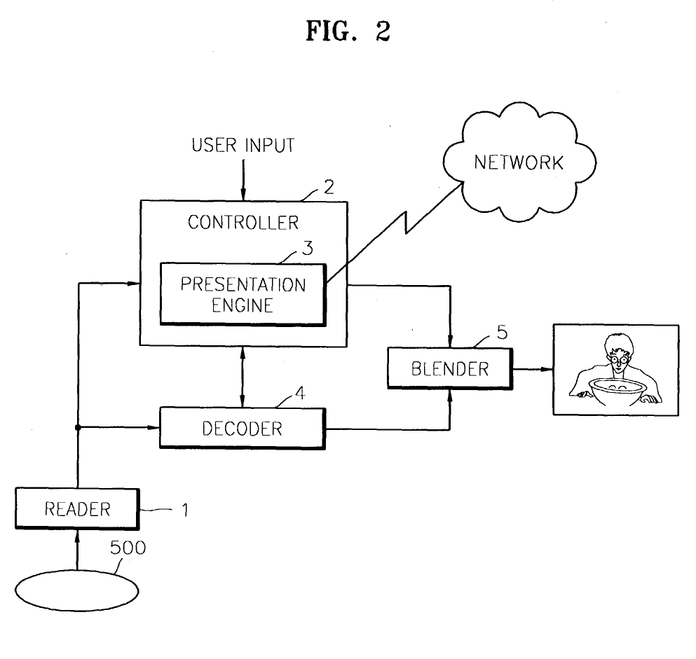

FIG. 2 is a functional block diagram of a reproducing apparatus in the reproducing system shown in FIG. 1.

Referring to FIG. 2, the reproducing apparatus 200 includes a reader 1, a controller 2, a decoder 4, and a blender 5. A presentation engine 3 is mounted in the controller 2.

The reader 1 reads the AV data, markup language documents, and navigation information from the DVD 500. Also, the reader 1 reads mode information data and/or reproducing state information data from the DVD 500. The mode information data and/or reproducing state information data are data that are needed to display the mode information/reproducing state information which will be described later, and are implemented as graphic data in embodiments of the present invention.

The controller 2 controls the presentation engine 3, the decoder 4, and the blender 5 so that the AV data recorded on the DVD 500 are reproduced in the interactive mode, the video mode, or the full-screen mode of the interactive mode according to the control command. The interactive mode and the video mode are upper level modes, and the full-screen mode is a lower level mode, such as the subordinate mode of the interactive mode.

The presentation engine 3 fetches the markup language document from a predetermined node of the network and interprets and executes the fetched markup language document. That is, the presentation engine 3 is an interpretation engine which interprets and executes a client interpretation program language, for example, JavaScript, or Java. In addition, the presentation engine 3 may further include a plug-in. The plug-in enables files to be open with a variety of formats included in or linked to the markup language document. In the interactive mode, the presentation engine 3 fetches the markup language document from the DVD 500 or from a predetermined node of the network, interprets the document, and confirms a display window on which an AV data stream output from the decoder 4 is to be displayed. The blender 5 blends the AV data stream and the interpreted markup language document so that the decoded AV data stream is displayed on the display window defined by the markup language document, that is, so that the AV screen is embedded in a markup screen of the display window of the markup language document. Then, the blender 5 outputs a blended result to the TV 100. In particular, the controller 2 displays mode information and/or reproducing state information to overlap the AV screen in the full-screen mode. The mode information and/or reproducing state information may be stored in the DVD 500 or a memory (not shown) of the reproducing apparatus 200 in advance.

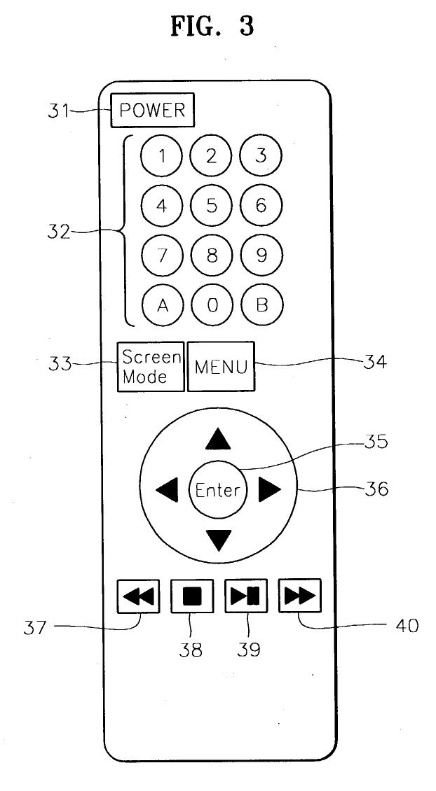

FIG. 3 is an example of a remote controller in the reproducing system shown in FIG. 1.

Referring to FIG. 3, the remote controller 400 has a variety of function buttons. A power button turning on/off power of the reproducing apparatus 200 is at a top of a front surface of the remote controller 400. Numerical/special character buttons 32 selecting channel numbers or other elements are arranged under the power button 31. A screen mode button 33 is used in selecting the full-screen mode from the interactive mode according to the present invention. A menu button 34 is to call a menu screen. The menu screen displays a menu supported by menu data recorded on the DVD 500. Reference number 36 indicates direction keys for moving a highlight part displayed on a screen of the TV 100. An enter button 35 is to select the menu on which the highlight part is placed. The remote controller 400 further includes a backward button 37, a stop button 38, a play/pause button 39, and a forward button 40.

The remote controller 400 of FIG. 3 is an example prepared to correspond to the DVD 500 on which video titles and markup language documents are recorded. Therefore, specific function buttons and the number of buttons may be changed. Also, at least some of the function buttons can be included in an on screen display (OSD) menu, or some functions of an OSD menu can be implemented by the function buttons.

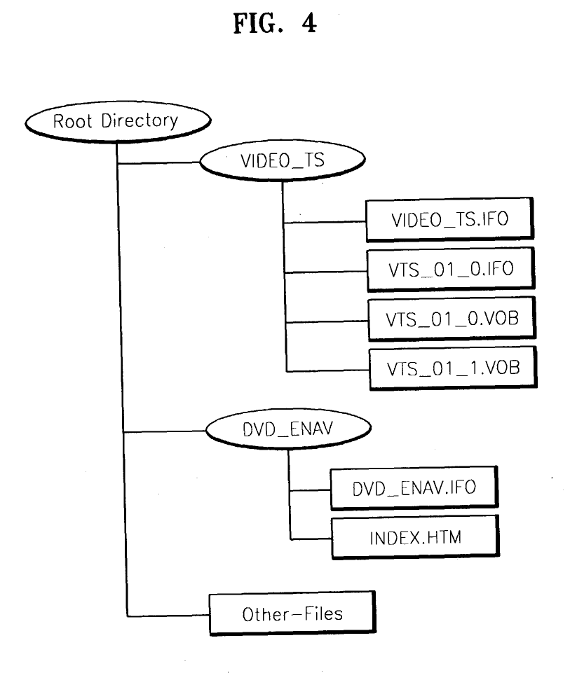

FIG. 4 is an example of a directory structure of the DVD 500 supporting interactive mode.

Referring to FIG. 4, a video directory VIDEO_TS containing AV data is included in a root directory. A file VIDEO_TS.IFO in which navigation information on the entire video titles is recorded, is placed in the video directory VIDEO_TS. Then, a file VTS_{—}01_{—}0.IFO in which navigation information on a first video title set is recorded, and VTS_{—}01_{—}0.VOB, VTS_{—}01_{—}1.VOB, . . . that form the first video title set are recorded. VTS_{—}01_{—}0.VOB, VTS_{—}01_{—}1.VOB, . . . are video titles forming the first video title set, that is, video objects. Each VOB contains VOBUs in which a navigation pack, a video pack, and an audio pack are packed. A more detailed structure is described in a DVD-Video standard DVD-Video for Read Only Memory disc 1.0.

The root directory also has an interactive directory DVD_ENAV storing information supporting the interactive mode. A navigation file DVD_ENAV.IFO is recorded in the interactive directory DVD_ENAV. For example, in the navigation file DVD_ENAV.IFO, a definition of a directory, a structure, the number of contained titles, basic information on titles, language used in the titles, caption, font information, markup language document display information, such as resolution and colors, and copyright information are recorded. Also, in the interactive directory DVD_ENAV, an index document INDEX.HTM to be displayed together with the video titles, and other markup language documents are stored. In addition, files that should be inserted into the markup language document, such as INDEX.HTM, and displayed together may be stored in the interactive directory DVD_ENAV.

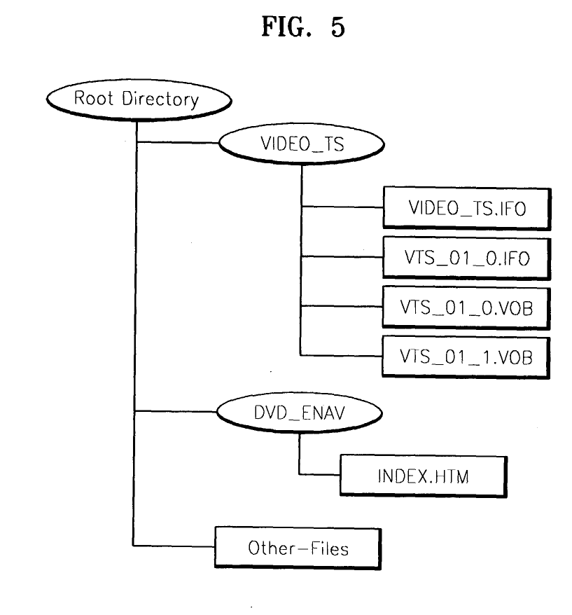

FIG. 5 is another example of a directory structure of the DVD 500 supporting the interactive mode. Referring to FIG. 5, another video directory VIDEO_TS having the same structure as that of FIG. 4 is in the root directory. Also, in the root directory, another interactive directory DVD_ENAV storing information supporting the interactive mode is placed. In the interactive directory DVD_ENAV of FIG. 5, the navigation file DVD_ENAV.IFO of FIG. 4 is not recorded unlike that of FIG. 4. An index document INDEX.HTM, and other markup language documents that are to be displayed together with the video titles, and the files that should be inserted into the markup language documents, such as INDEX.HTM, and displayed together are stored in the interactive directory DVD_ENAV.

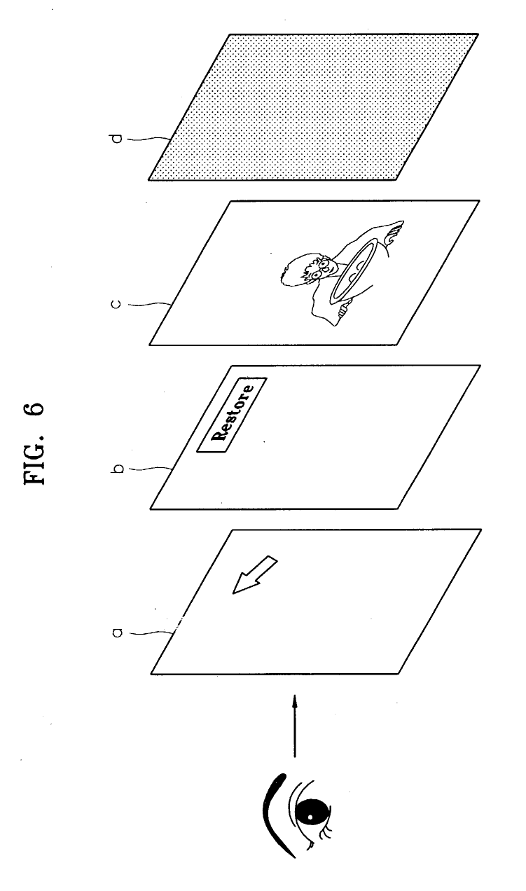

FIG. 6 is a reference diagram for explaining a screen line-up order (Z-order) of the TV 100 connected to the reproducing apparatus 200 shown in FIGS. 1 and 2. Referring to FIG. 6, a final screen seen to the user is generated by physically adding four screens. A screen (a) on which a pointer is displayed is placed at the front, and a graphic screen (b) on which the markup screen based on the markup language document and mode information and/or reproducing state information are displayed is placed next. Then, an AV screen (c) with AV data is placed, and a background screen (d) which is usually expressed by one color is finally placed.

FIG. 7 is a reference diagram explaining the video mode. Referring to FIG. 7, if the user places the DVD 500 in the reproducing apparatus 200 and selects the video mode in the menu screen displayed on the TV 100, the AV screen (b) is displayed in an empty (blank) screen (a).

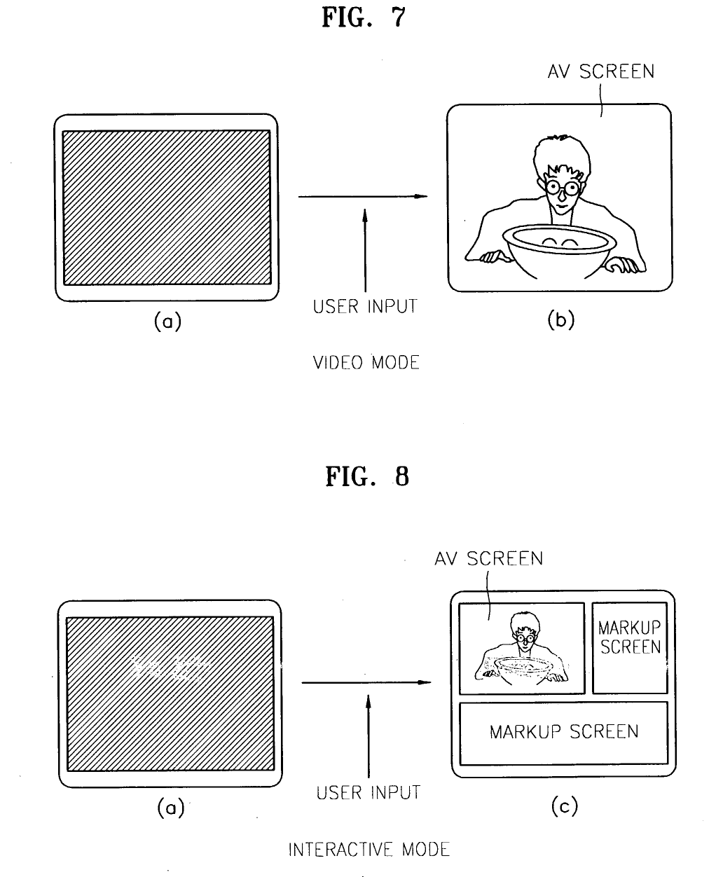

FIG. 8 is another reference diagram explaining the interactive mode. Referring to FIG. 8, the user places the DVD 500 in the reproducing apparatus 200 and selects an interactive mode in the menu screen displayed on the TV 100.

When the DVD 500 has the directory structure shown in FIG. 4, the reproducing apparatus 200 reads the navigation file DVD_ENAV.IFO recorded on the DVD 500, then interprets the navigation file DVD_ENAV.IFO, reads the index document INDEX.HTM that is determined as a start document, and reproduces a corresponding video title based on the index document INDEX.HTM. Also, since the navigation file DVD_ENAV.IFO is linked to the index document INDEX.HTM, if the user wants to change a resolution of the screen or a language of language information displayed on the markup screen, through the navigation file DVD_ENAV.IFO, another new index document INDEX.HTM is visited (searched) and then read so that another corresponding video title can be reproduced based on the new index document INDEX.HTM. As a result, from a state where nothing is displayed in the blank screen (a) of FIG. 8, the screen enters the interactive mode where the AV screen on which the video title is reproduced and the markup screen on which the markup language document is reproduced are displayed together as shown in a screen (c) of FIG. 8.

When the DVD 500 has the directory structure shown in FIG. 5, the reproducing apparatus 200 directly reads a corresponding index document INDEX.HTM and reproduces a corresponding video title in an interactive mode based on the read index document INDEX.HTM. As a result, from the state where nothing is displayed in the empty screen (a) of FIG. 8, the screen enters the interactive mode where the AV screen on which the video title is reproduced and the markup screen on which a markup language document is reproduced are displayed together as shown in the screen (c) of FIG. 8.

The following is an example of the index document INDEX.HTM read from the DVD 500.

<?xml version=“1.0”?>

<!DOCTYPE html PUBLIC -//DVD//DTD XHTML DVD-HTML 1.0//EN

“http://www.dvdforum.org/enav/dtd/dvdhtml-1-0.dtd”>

<html>

<head>

<title>example of startup HTML file of a disc</title>

<link rel=“StyleSheet” type=“text/css” href=“harrypotter.css”/>

<link rel=“dvdenav” type=“application/dvd.enav” href=“dvd://dvd_enav/dvd-enav.ifo”/>

</head>

<body>

<script language=“ecmascript”>

<!--

DvdVideo.Play( );

-->

</script>

</body>

</html>

</html>

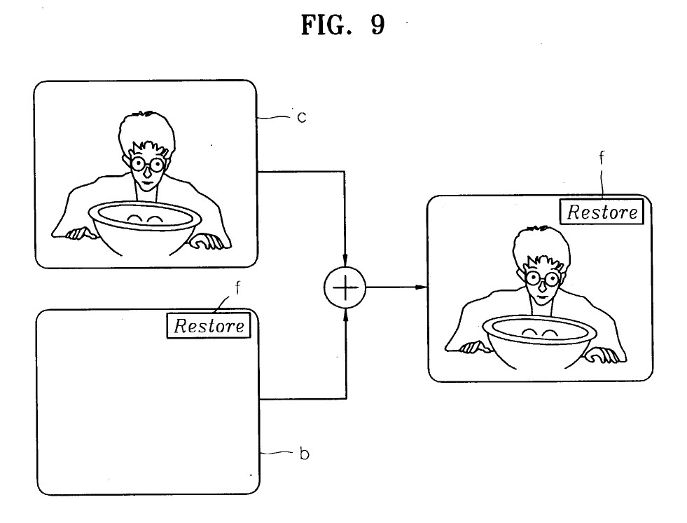

FIG. 9 is a reference diagram explaining the structure of a screen on which the mode information is displayed in the reproducing system shown in FIG. 1.

Referring to FIG. 9, the screen which is seen by the user is formed by overlapping the AV screen (c) of FIG. 6 and the graphic screen (b) of FIG. 6 containing the mode information implemented as graphic data (f). A screen on which the reproducing state information implemented as the graphic data (f) is displayed, is formed in the same manner as shown in FIGS. 6 and 8.

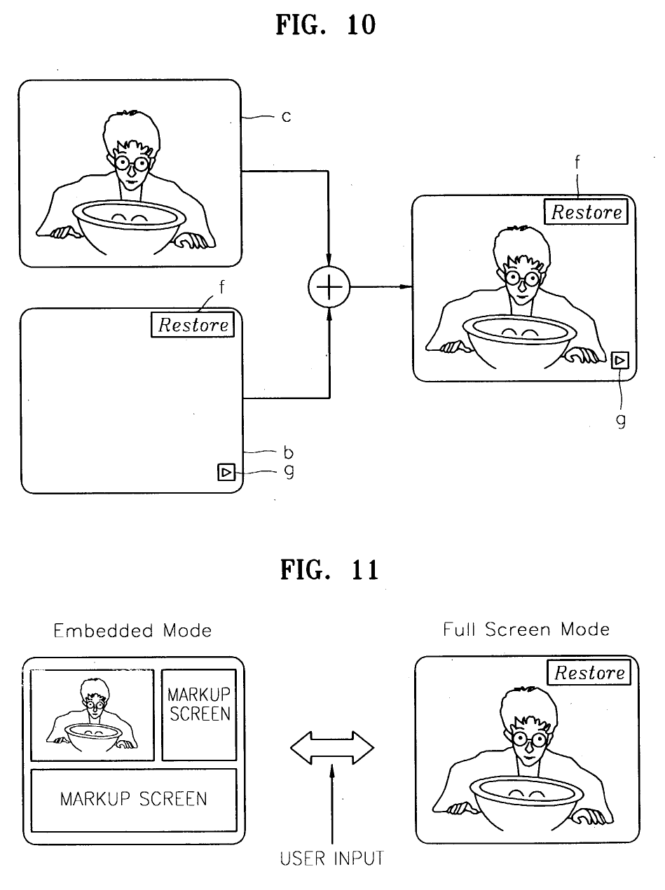

FIG. 10 is a reference diagram explaining the structure of the screen on which the mode information and the reproducing state information are displayed in the reproducing system shown in FIG. 1.

Referring to FIG. 10, the screen which is seen by a user is formed by overlapping the AV screen (c) of FIG. 6 and the graphic screen (b) of FIG. 6 containing the mode information and the reproducing state information implemented as graphic data (f) and (g), respectively.

FIG. 11 is a reference diagram explaining the screen on which the mode information is displayed when a screen mode is in transit from the interactive mode to a full-screen mode that is a subordinate mode of the interactive mode in the reproducing system shown in FIG. 1.

Referring to FIG. 11, the interactive mode has an embedded mode and the full-screen mode as its subordinate modes. However, since the embedded mode is set as a default value, if the user selects the interactive mode, the screen is displayed in the embedded mode. At this time, if the user selects the full-screen mode (if the screen mode button 33 of FIG. 3 is pushed), the AV screen expands to an entire screen, and the AV screen expanding to the entire screen is displayed. Also, information indicating that a current mode is the full-screen mode, which is a subordinate mode of the interactive mode, that is, the mode information, is displayed as a graphic icon overlapping the AV screen. If the user selects the embedded mode again (if the screen mode button 33 of FIG. 3 is pushed), the AV screen shrinks, and the shrunk AV screen is displayed, and the once disappeared markup screen is displayed again.

To the user, the AV screen in the full-screen mode is the same as the AV screen in the video mode. At this time, the mode information informs the user that the current mode is the interactive mode, even though the markup screen indicating the interactive mode has been disappeared.

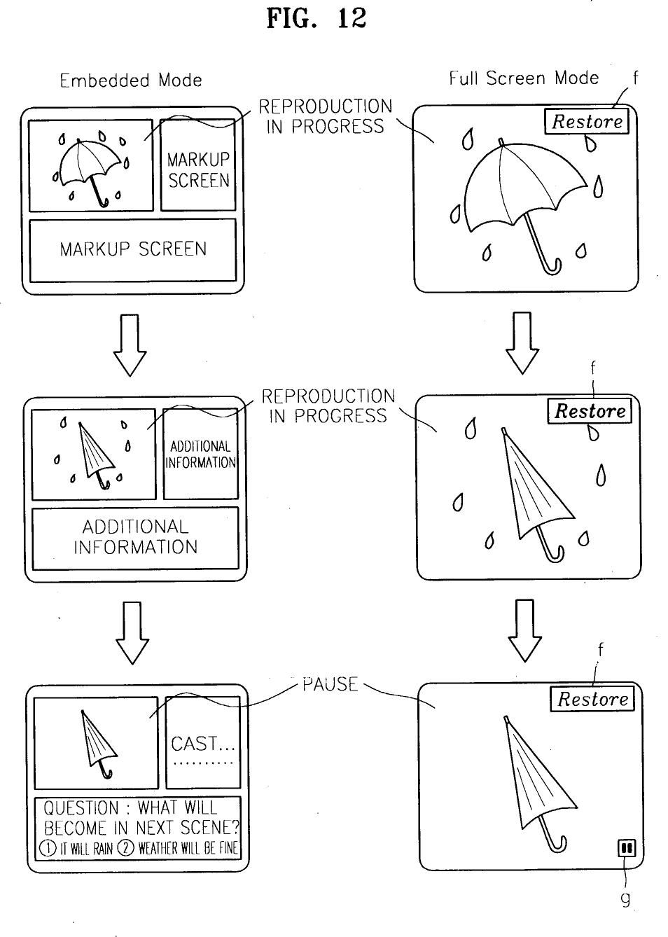

FIG. 12 is a reference diagram for explaining a process in which mode information and reproducing state information are displayed when the screen mode is changed from the interactive mode to the full-screen mode that is the subordinate mode of the interactive mode in the reproducing system shown in FIG. 1.

Referring to FIG. 12, if the screen is changed from the embedded mode to the full-screen mode, the markup screen disappears, the AV screen expands to the entire screen and the expanded AV screen is displayed, and the mode information implemented as the graphic icon (f) is displayed overlapping the AV screen. If reproduction of the AV data is paused when a predetermined event defined in the markup language document occurs in the full-screen mode, the AV screen stops and reproducing state information implemented as the graphic icon (g) is displayed. By the reproducing state information, i.e., the graphic icon (g), the user is informed that reproduction of the AV data is paused when the predetermined event defined in the markup language document occurs.

A display method will now be explained based on the structure described above.

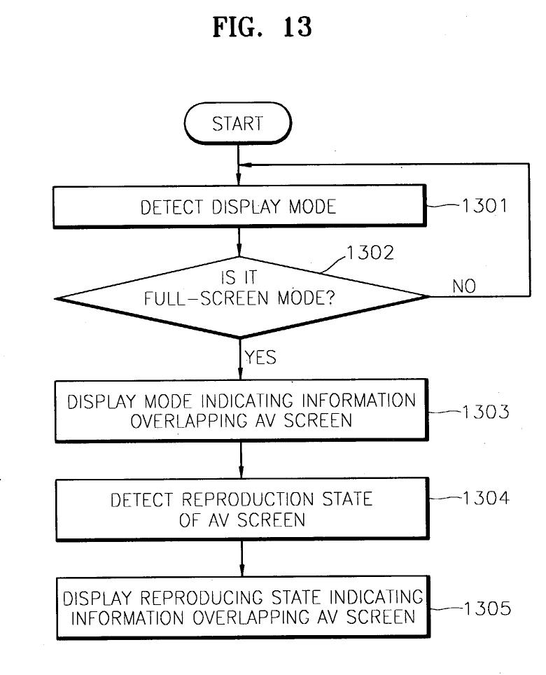

FIG. 13 is a flowchart explaining the display method in the reproducing system shown in FIG. 1.

Referring to FIG. 13, the reproducing apparatus 200 detects the current display mode in the interactive mode in operation 1301. If the current mode is the full-screen mode in operation 1302, the reproducing apparatus 200 displays the mode information overlapping the current AV screen in operation 1303. In addition, the reproducing apparatus 200 detects a reproducing state of the current AV data in operation 1304 and displays the reproducing state information that is read from the DVD 500 or stored in a memory (not shown) of the reproducing apparatus 200, such that the reproducing state information overlaps the AV screen in operation 1305.

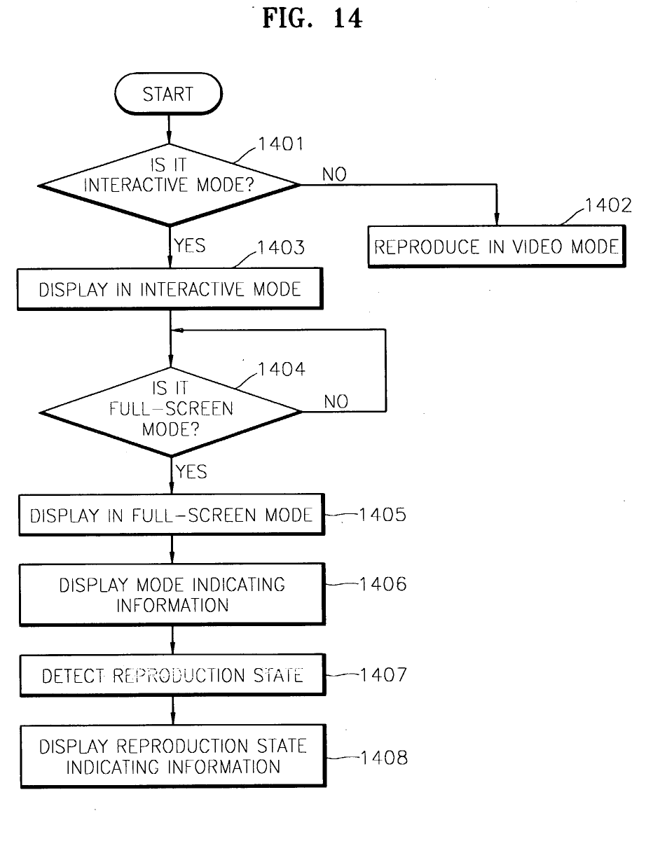

FIG. 14 is another flowchart explaining the display method in the reproducing system shown in FIG. 1.

Referring to FIG. 14, if the user places the DVD 500 in the reproducing apparatus 200, the menu screen for selecting the display mode, that is, the menu screen on which any one of the video mode and the interactive mode can be selected, is displayed on the TV 100. If the user selects the video mode rather than the interactive mode, in operation 1401, the reproducing apparatus 200 reproduces a corresponding video title in the video mode in operation 1402.

If the user selects the interactive mode, the reproducing apparatus 200 displays a corresponding video title in the interactive mode in operation 1403. If the user selects the full-screen mode in step 1404, the presentation engine 3 expands the AV screen to cover the entire screen and displays the AV screen in the full-screen mode in operation 1405. At the same time, the presentation engine 3 reads the mode information data from the DVD 500 or the memory of the reproducing apparatus 200 and displays the corresponding mode information overlapping the AV screen in operation 1406. Also, the presentation engine 3 detects the reproducing state of the current AV data from the decoder 4 in operation 1407, reads the reproducing state information data from the DVD 500 or the memory of the reproducing apparatus 200, and displays the corresponding reproducing state information overlapping the AV screen in operation 1408.

Meanwhile, although the mode information and the reproducing state information are both displayed by overlapping the AV screen in the above embodiment, these may be displayed separately.

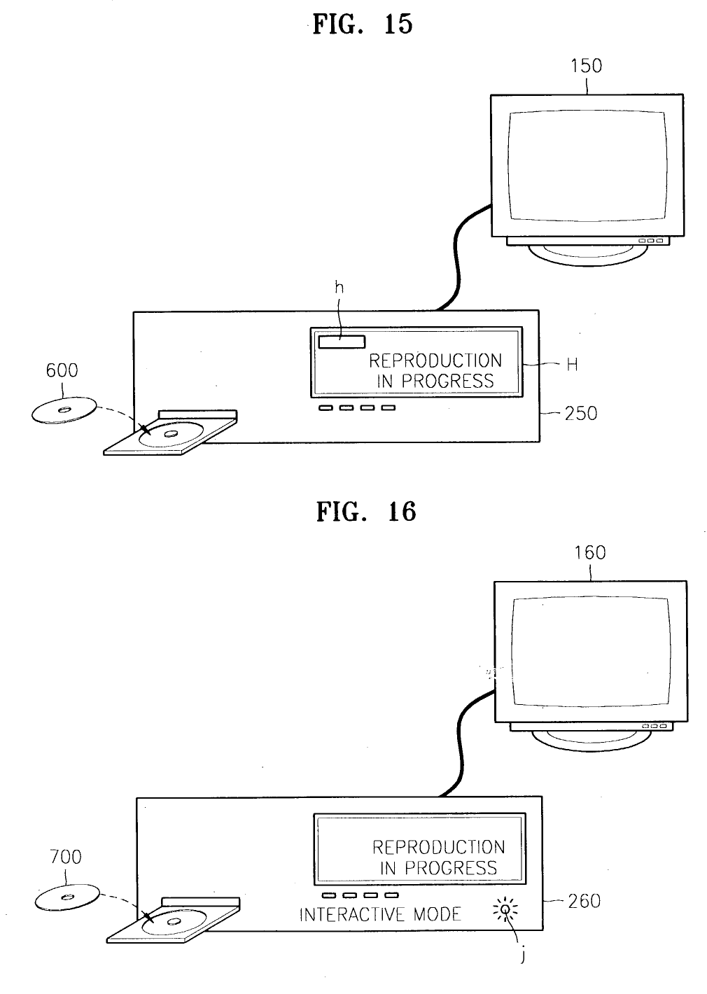

FIG. 15 is a diagram of another reproducing system displaying mode information and reproducing state information according to another embodiment of the present invention.

Referring to FIG. 15, the reproducing system includes an information storage medium (disc) 600 storing AV data, markup documents for reproducing the AV data in an interactive mode, and mode information and/or reproducing state information, a reproducing apparatus 250 reproducing the AV data recorded on the disc 600, and a display apparatus 150 displaying the AV data reproduced by the reproducing apparatus 250.

The reproducing apparatus 250 reads the mode information and/or the reproducing state information from the disc 600 and displays the information on a display window (H) on a panel of the reproducing apparatus 250. Accordingly, on the display window (H), the mode information and/or the reproducing state information are displayed.

FIG. 16 is another diagram of another reproducing system showing mode information and reproducing state information according to another embodiment of the present invention.

Referring to FIG. 16, the reproducing system includes an information storage medium (disc) 700 storing AV data, markup documents for reproducing AV data in the interactive mode, and mode information and/or reproducing state information, a reproducing apparatus 700 for reproducing the AV data recorded on the disc 700, and a display apparatus 160 displaying the AV data reproduced by the reproducing apparatus 260.

The reproducing apparatus 260 reads the mode information and/or the reproducing state information from the disc 700 and displays the information on a panel on a front surface of the reproducing apparatus 260. Accordingly, the mode information and/or the reproducing state information are displayed on the panel. FIG. 16 shows an example in which, by turning on an LED (j) indicating the interactive mode, it is indicated that the screen displayed on the current display apparatus 160 is in the interactive mode. The reproducing state information can also be displayed in the same manner.

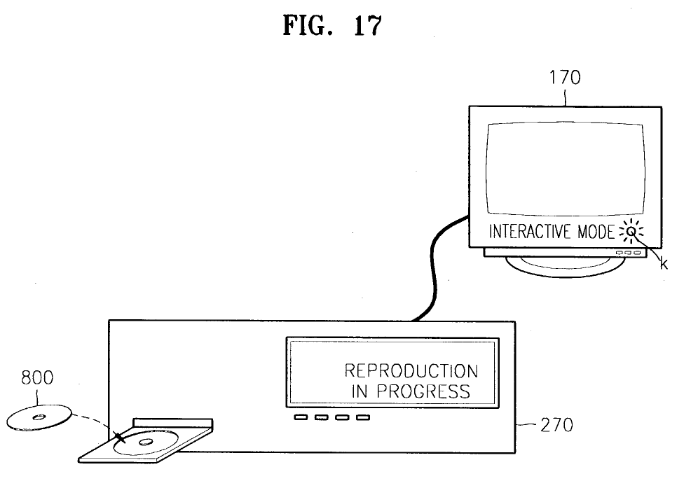

FIG. 17 is another diagram of another reproducing system outputting mode information and reproducing state information according to another embodiment of the present invention.

Referring to FIG. 17, the reproducing system includes an information storage medium (disc) 800 storing AV data, markup documents for reproducing AV data in the interactive mode, and mode information and/or reproducing state information, a reproducing apparatus 800 reproducing the AV data recorded on the disc 800, and a display apparatus 170 displaying the AV data reproduced by the reproducing apparatus 270.

The reproducing apparatus 270 reads the mode information and/or the reproducing state information from the disc 800 and displays the information on a panel on a front surface of the display apparatus 170. Accordingly, on the panel, the mode information and/or the reproducing state information are displayed. FIG. 17 shows an example in which, by turning on an LED (k) indicating the interactive mode, it is indicated that the screen displayed on the current display apparatus 170 is in the interactive mode. The reproducing state information can also be displayed in the same manner.

Meanwhile, although the mode information and the reproducing state information are implemented as the graphic data in the embodiments described above, these can also be implemented as text data or moving graphic data.

According to the present invention as described above, even in the interactive mode, the AV screen can be expanded to the entire screen and the enlarged AV screen can be seen in the full-screen mode, and the mode information is displayed together in order to indicate that the current mode is the full-screen mode in the interactive mode such that the information on the current display mode is provided to the user. In addition, in the full-screen mode, the reproducing state information is displayed to overlap the AV screen so that the user can be informed of the current reproducing state on the AV data. Accordingly, a user-friendly interface that informs the user of correct information on the current display mode and the reproducing state is provided.

Although a few preferred embodiments of the present invention have been shown and described, it would be appreciated by those skilled in the art that changes may be made in this embodiment without departing from the principles and sprit of the invention, the scope of which is defined in the claims and their equivalents.

What is claimed is:

1. An information storage medium encoded with data readable by a computer to implement a method of displaying a plurality of display modes including an interactive mode on a display screen, the medium comprising:
audio/video (AV) data used to generate an AV screen;
a markup language document used to define a display window of the display screen on which the AV screen is output and reproduced based on the AV data in an interactive mode; and
mode information used to indicate a current display mode corresponding to one of the display modes when the AV screen is displayed on the display screen in the one of the display modes.

2. The information storage medium of claim 1, wherein the mode information is displayed to overlap the AV screen obtained from the AV data.

3. The information storage medium of claim 1, wherein the computer comprises a reproducing apparatus reading the data from the medium and having a panel as a second display screen, and the mode information is displayed on the panel of the reproducing apparatus which reproduces the AV data.

4. The information storage medium of claim 3, wherein the panel comprises a display window, and the mode information is displayed on the display window of the panel.

5. The information storage medium of claim 1, wherein the computer is connected to a display apparatus having the display screen, and the mode information is displayed on the display apparatus.

6. The information storage medium of claim 1, wherein the mode information is displayed as graphic data.

7. The information storage medium of claim 1, wherein the display modes comprise an upper level mode and a subordinate mode of the upper level mode, and the mode information indicates the upper level mode when the AV screen is displayed in the subordinate mode of the upper level mode.

8. The information storage medium of claim 7, wherein the mode information is to indicate a full-screen mode as the subordinate mode of the interactive mode when the AV screen is displayed in the full-screen mode of the interactive mode.

9. The information storage medium of claim 1, wherein the markup language document contains additional information relating to the AV screen.

10. The information storage medium of claim 9, wherein the additional information comprises:
at least one of text information, image information, and moving picture information relating to the AV screen.

11. The information storage medium of claim 9, further comprising:
a separate file representing the additional information and linked to the markup language document.

12. An information storage medium encoded with data readable by a computer to implement a method of displaying a reproducing state of an AV screen on a display screen, the medium comprising:
audio/video (AV) data used to generate an AV screen;
a markup language document used to define a display window of the display screen on which the AV screen is output and reproduced in an interactive mode; and
reproducing state information used to indicate information on the reproducing state of the AV screen obtained based on the AV data in the interactive mode and is displayed on the screen when the AV screen is displayed on the display screen.

13. The information storage medium of claim 12, wherein the reproducing state information is displayed to overlap the AV screen obtained from the AV data.

14. The information storage medium of claim 12, wherein the computer comprises a reproducing apparatus having a panel as a second display screen, and the reproducing state information is displayed on the panel of the reproducing apparatus which reproduces the AV data from the medium.

15. The information storage medium of claim 14, wherein the panel comprises a display window, and the reproducing state information is displayed on the display window of the panel.

16. The information storage medium of claim 12, wherein the computer is connected to a display apparatus providing the screen, and the reproducing state information is displayed on the screen of the display apparatus.

17. The information storage medium of claim 12, wherein the reproducing state information is displayed as graphic data.

18. The information storage medium of claim 12, wherein the reproducing state information indicates that the reproduction of the AV data is paused.

19. The information storage medium of claim 12, wherein the reproducing state information indicates that the reproduction of the AV data is paused when the AV screen is displayed in a full-screen mode of the interactive mode.

20. An apparatus for reproducing data from an information storage medium in a plurality of display modes on a display screen, comprising:
a reader which reads the AV data from the information storage medium;
a decoder which decodes the AV data read by the reader to obtain an AV screen; and
a controller which detects one of the display modes of the AV screen obtained from the decoded AV data, and displays mode information indicating the detected one of the display modes on the display screen when the AV screen is displayed in the one of the display modes.

21. The reproducing apparatus of claim 20, wherein the controller displays the mode information to overlap the AV screen obtained from the AV data.

22. The reproducing apparatus of claim 20, wherein the reproducing apparatus comprises a panel as a second display screen, and the controller displays the mode information, on the panel of the reproducing apparatus.

23. The reproducing apparatus of claim 22, wherein the panel comprises a display window, and the controller displays the mode information on the display window of the panel.

24. The reproducing apparatus of claim 20, wherein the apparatus is connected to an external display apparatus, and the controller outputs the mode information to be displayed on the display apparatus.

25. The reproducing apparatus of claim 20, wherein the display modes comprises an upper level mode having an interactive mode and a video mode, and a lower level mode having an embedded mode and a full-screen mode as a subordinate mode of the upper level mode, and the controller displays the mode information which indicates the upper level mode when the AV screen is displayed in the subordinate mode of the upper level mode.

26. The reproducing apparatus of claim 25, wherein the controller displays the mode information indicating the full-screen mode as the subordinate mode of the interactive mode when the AV screen is displayed in the full-screen mode of the interactive mode.

27. The reproducing apparatus of claim 26, wherein the mode information comprises a graphic screen, and the controller displays the graphic screen such that the graphic screen overlaps the AV screen in the full-screen mode.

28. The reproducing apparatus of claim 26, wherein the controller displays the AV screen on an entire display screen in the full-screen mode of the interactive mode.

29. The reproducing apparatus of claim 25, wherein the controller displays the AV screen on an entire display screen in the video mode.

30. The reproducing apparatus of claim 29, wherein the information storage medium stores a markup language document defining a display window, and the controller displays the AV screen on the display window defined in the markup language document in the interactive mode.

31. A reproducing apparatus coupled to a display screen, comprising:
a reader which reads data having AV data from an information storage medium;
a decoder which decodes the AV data read by the reader to obtain an AV screen; and
a controller which detects information on a reproducing state of the AV screen obtained based on the AV data and displays the reproducing state information of the AV data read by the reader on the display screen.

32. The reproducing apparatus of claim 31, wherein the controller displays the reproducing state information to overlap the AV screen obtained from the AV data.

33. The reproducing apparatus of claim 32, wherein the controller displays the reproducing state information indicating that reproduction of the AV data is paused, so that the reproducing state information overlaps the AV screen.

34. The reproducing apparatus of claim 31, wherein the apparatus comprises a panel as the second display screen, and the controller displays the reproducing state information on the panel of the reproducing apparatus.

35. The reproducing apparatus of claim 31, wherein the panel comprises a display window, and the controller displays the reproducing state information on the display window of the panel.

36. The reproducing apparatus of claim 31, wherein the apparatus is connected to an external display apparatus, and the controller displays the reproducing state information on the predetermined display apparatus.

37. The reproducing apparatus of claim 31, wherein the controller displays the reproducing state information which indicates that reproduction of the AV data is paused when the AV screen is displayed in the full-screen mode of the interactive mode.

38. A reproducing method by which AV data recorded on an information storage medium is reproduced in an interactive mode, the method comprising;
detecting a display mode of an AV screen obtained from the AV data; and
displaying mode information which indicates that the display mode is a full-screen mode as a subordinate mode of the interactive mode when the display mode is the full-screen mode.

39. The method of claim 38, wherein the displaying of the mode information comprises:
displaying the mode information to overlap the AV screen obtained from the AV data.

40. The method of claim 38, wherein the displaying of the mode information comprises:
displaying the mode information on a panel of the reproducing apparatus.

41. The method of claim 38, wherein the displaying of the mode information comprises:
displaying the mode information on a display window of the panel.

42. The method of claim 38, wherein the displaying of the mode information comprises:
displaying the mode information on an external display apparatus.

43. The method of claim 38, wherein the mode information comprises a graphic screen, and the displaying of the mode information comprises:
displaying the mode information to overlap the AV screen.

44. A reproducing method by which AV data recorded on an information storage medium is reproduced in an interactive mode, the method comprising:
detecting information on a reproducing state of the AV screen when the display mode of the AV screen obtained from the AV data is a full-screen mode; and
displaying reproducing state information which indicates the detected reproducing state of the AV screen.

45. The method of claim 44, wherein the displaying of the reproducing state information comprises:
displaying the reproducing state information to overlap the AV screen obtained from the AV data.

46. The method of claim 44, wherein the displaying of the reproducing state information comprises:
displaying the reproducing state information on a panel of the reproducing apparatus.

47. The method of claim 44, wherein the displaying of the reproducing state information comprises:
displaying the reproducing state information on a display window of the panel.

48. The method of claim 44, wherein the displaying of the reproducing state information comprises:
displaying the reproducing state information on a predetermined display apparatus.

49. The method of claim 44, wherein the displaying of the reproducing state information comprises:
displaying the reproducing state information indicating that reproduction is paused.

50. An apparatus for reproducing data from a medium in a plurality of display modes on a display screen, comprising:
a reader which reads AV data from the medium;
a decoder which decodes the AV data read by the reader to obtain an AV screen; and
a controller which detects one of mode information which represents corresponding one of the display modes, and reproducing state information which represents a state of reproducing the AV data from the medium, from the decoded AV data, and displays at least one of the mode information and the reproducing state information on the display screen when the AV screen is displayed in the one of the display modes.

51. The reproducing apparatus of claim 50, wherein the display modes comprise an upper level mode which includes a video mode and an interactive mode, and a lower level mode which includes an embedded mode of the interactive mode and a full-screen mode of the interactive mode, and the mode information indicates the full-screen mode of the interactive mode when the AV screen is displayed in the full-screen mode of the interactive mode.

52. The reproducing apparatus of claim 51, wherein the reproducing state information indicates that the reproducing of the AV data from the medium is paused.

53. The reproducing apparatus of claim 51, wherein the medium comprises:
a disc type medium directly loaded in the reproducing apparatus and read by the reader.

54. The reproducing apparatus of claim 51, wherein the reader of the reproducing apparatus is connected to an external network, and the medium comprises:
an external medium disposed on an outside of the reproducing apparatus to be connected through the network.

55. The reproducing apparatus of claim 51, wherein the medium comprises:
a memory disposed in an inside of the reproducing apparatus and read by the reader.

56. The reproducing apparatus of claim 51, wherein the reproducing apparatus is connected to an external display apparatus having the display screen, and the controller outputs both the AV screen and the one of the mode information and the reproducing state information to the display apparatus to be simultaneously displayed on the display screen of the display apparatus in the full-screen mode of the interactive mode.

57. The reproducing apparatus of claim 56, wherein the AV screen and the one of the mode information and the reproducing state information overlap on the display screen of the display apparatus.

58. The reproducing apparatus of claim 51, wherein the reproducing apparatus is connected to an external display apparatus having the display screen and further comprises a second display screen disposed on the reproducing apparatus, and the controller outputs the AV screen to the display apparatus to be displayed on the display screen of the display apparatus in the full-screen mode of the interactive mode and displays the one of the mode information and the reproducing state information on the second display screen.

59. The reproducing apparatus of claim 58, wherein the reproducing apparatus comprises:
an LED as the second display screen, indicating one of the mode information and the reproducing state information.

60. The reproducing apparatus of claim 51, wherein the one of the mode information and the reproducing state information on the second display screen comprises:
one of a graphic icon, graphic data, text data, and moving graphic data.

61. An apparatus for receiving data from a medium in a plurality of display modes on a display apparatus, comprising:
a decoder which decodes AV data from the received data to obtain an AV screen; and
a controller which detects at least one of mode information which represents one of the display modes, and reproducing state information which represents a state of reproducing the AV data from the medium, from the decoded AV data, and outputs both the AV screen and the at least one of the mode information and the reproducing state information when the AV screen is outputted in a full-screen mode of an interactive mode of the display modes.

62. The reproducing apparatus of claim 61, wherein the controller transmits both the AV screen and the at least one of the mode information and the reproducing state information to the display apparatus so that both the AV screen and the at least one of the mode information and the reproducing state information overlap on the display apparatus.

63. The reproducing apparatus of claim 61, further comprising:
a display panel, wherein the controller transmits the AV screen to the display apparatus to display the AV screen on the display apparatus and the at least one of the mode information and the reproducing state information to the display panel.

64. The reproducing apparatus of claim 63, wherein the display apparatus is disposed in an outside of the reproducing apparatus and coupled through a connector, and the display panel is a portion of the reproducing apparatus.

65. An apparatus for reproducing AV data from a medium in an interactive mode on a display apparatus, comprising:
a decoder which decodes the AV data to obtain an AV screen; and
a controller which expands the AV screen of an embedded mode of the interactive mode to an enlarged AV screen of a full-screen mode of the interactive mode and displays the enlarged AV screen together and mode information representing that a current mode is the full-screen mode, on the display apparatus in the full-screen mode of the interactive mode.

66. A reproducing method of reproducing data from a medium in a plurality of display modes on a display screen, the method comprising:
reading AV data from the medium;
decoding the AV data read by the reader to obtain an AV screen;
detecting one of mode information which represents one of the display modes, and reproducing state information which represents a state of reproducing the AV data from the medium, from the decoded AV data; and
displaying at least one of the mode information and the reproducing state information on the display screen when the AV screen is displayed in the one of the display modes.

67. A reproducing method in which data is received from a medium in a plurality of display modes and displayed on a display apparatus, the method comprising:
decoding AV data from the received data to obtain an AV screen;
detecting at least one of mode information which represents one of the display modes, and reproducing state information which represents a state of reproducing the AV data from the medium, from the decoded AV data; and
outputting both the AV screen and the at least one of the mode information and the reproducing state information when the AV screen is outputted in a full-screen mode of an interactive mode of the display modes.

68. A reproducing method in which an AV screen is displayed on a display apparatus in an embedded mode of an interactive mode, the method comprising:
expanding the AV screen of the embedded mode of the interactive mode to an enlarged AV screen of a full-screen mode of the interactive mode to display the enlarged AV screen on the display apparatus in the full-screen mode of the interactive mode; and
displaying the enlarged AV screen and mode information representing that a current mode is the full-screen mode of the interactive mode, on the display apparatus in the full screen mode of the interactive mode.
